(19) United States
(12) Patent Application Publication
(10) Pub. No.: US 2026/0112782 A1
(43) Pub. Date: Apr. 23, 2026

(54) BATTERY PACK INTERCONNECT ASSEMBLY FOR A BATTERY PACK

(71) Applicant: TE Connectivity Solutions GmbH, Schaffhausen (CH)

(72) Inventor: Evan DAWLEY, Troy, MI (US)

(21) Appl. No.: 19/212,900

(22) Filed: May 20, 2025

Related U.S. Application Data
(60) Provisional application No. 63/710,357, filed on Oct. 22, 2024.

(51) Int. Cl. H01M 50/507; H01M 10/42; H01M 10/48; H01M 50/569

(52) U.S. Cl. CPC H01M 50/507; H01M 10/4257; H01M 10/482; H01M 10/486; H01M 50/569; H01M 2200/103

(57) ABSTRACT

A battery pack interconnect assembly for electrically connect cell terminals of battery cells in a battery pack includes a busbar interconnect with a busbar carrier holding a plurality of busbars each having first and second mating ends for mating with corresponding adjacent cell terminals. The battery pack interconnect assembly includes a sensing harness having sensing modules and sensing cables with sensing conductors coupled to the sensing modules. The sensing modules include sensing circuits electrically connected to the corresponding busbars at sensing points to sense a voltage of each of the corresponding busbars. The sensing cables span between the sensing modules with the sensing conductors electrically connected to the corresponding sensing circuits of the corresponding sensing modules. The sensing conductors of the sensing cables are electrically connected to a control module.

### CROSS REFERENCE TO RELATED APPLICATIONS

This application claims benefit to U.S. patent application Ser. No. 63/710,357, filed 22-Oct.-2024, the subject matter of which is herein incorporated by reference in its entirety.

### BACKGROUND OF THE INVENTION

The subject matter herein relates generally to battery packs, such as battery packs for electric vehicles.

Electric vehicles include a battery system including a battery pack having a large number of battery cells. A typical battery system requires a connectivity solution to transfer/distribute power between groups of battery cells and have provisions for sensing battery parameters like voltage and temperature. To transfer power, busbars (aluminum or copper) are usually welded to the cell terminals in serial and/or parallel electrical configuration. As electric vehicle applications proliferate, the overhead cost of components ($/kWh) is scrutinized and there is a desire to minimize costs, such as by minimizing the part count and part numbers. For battery systems of electric vehicles, the battery cell stack sizes are very large. Typically, assembly of the battery system requires many parts, which are individually assembled to the corresponding cell terminals, which is time consuming and adds cost to the assembly process. There is a need to monitor operating parameters of the components, such as voltages at each of the busbars, temperature, charge state, or other operating characteristics. Some systems use wire harnesses with sensors to monitor the components of the battery system. The wire harnesses add weight, cost, and assembly time.

A need remains for a method for assembling battery packs, such as for electric vehicles, in a cost effective and reliable manner.

### BRIEF DESCRIPTION OF THE INVENTION

In one embodiment, a battery pack interconnect assembly for electrically connect cell terminals of battery cells in a battery pack is provided. The battery pack interconnect assembly includes a busbar interconnect that includes a plurality of busbars arranged in a matrix that has multiple rows of the busbars and multiple columns of the busbars and a busbar carrier holding the busbars. Each busbar includes a first mating end for mating with the corresponding cell terminal of the corresponding battery cell and a second mating end for mating with the adjacent cell terminal of the adjacent corresponding battery cell. The busbars electrically connect the battery cells in the battery pack. The battery pack interconnect assembly includes a sensing harness that has sensing points coupled to the busbars. The sensing harness includes sensing modules and sensing cables coupled to the sensing modules. The sensing cables include sensing conductors. The sensing modules include sensing circuits electrically connected to the corresponding busbars at the sensing points to sense a voltage of each of the corresponding busbars. The sensing cables span between the sensing modules with the sensing conductors electrically connected to the corresponding sensing circuits of the corresponding sensing modules. The sensing conductors of the sensing cables are electrically connected to a control module.

In another embodiment, a sensing harness for sensing voltages of busbars electrically connected to cell terminals of battery cells in a battery pack is provided. The sensing harness includes sensing modules configured to be electrically connected to the corresponding busbars at sensing points to sense a voltage of each of the corresponding busbars. Each sensing module includes a sensing housing and a sensing circuit held by the sensing housing. The sensing circuits are configured to be electrically connected to the corresponding busbars. The sensing harness includes sensing cables extending parallel to each other in rows. The sensing cables are flat flexible cables that have a plurality of sensing conductors. The sensing cables span each of the sensing modules. The sensing conductors being electrically connected to the corresponding sensing circuits of each of the sensing modules. The sensing conductors of the sensing cables electrically connected to a control module.

In a further embodiment, a battery pack is provided and includes battery cells arranged in a matrix that has multiple rows and multiple columns of the battery cells. Each battery cell includes a first cell terminal and a second cell terminal. The battery pack includes a battery pack interconnect assembly electrically connected to the first and second cell terminals of the battery cells. The battery pack interconnect assembly includes a busbar interconnect and a sensing harness electrically connected to the busbar interconnect. The busbar interconnect includes a plurality of busbars arranged in a matrix that has multiple rows of the busbars and multiple columns of the busbars and a busbar carrier holding the busbars. Each busbar includes a first mating end for mating with the first cell terminal of the corresponding battery cell and a second mating end for mating with the second cell terminal of the adjacent corresponding battery cell. The busbars electrically connect the battery cells in the battery pack. The sensing harness has sensing points coupled to the busbars. The sensing harness includes sensing modules and sensing cables. The sensing cables include sensing conductors. The sensing modules include sensing circuits electrically connected to the corresponding busbars at the sensing points to sense a voltage of each of the corresponding busbars. The sensing cables span between the sensing modules with the sensing conductors electrically connected to the corresponding sensing circuits of the corresponding sensing modules. The sensing conductors of the sensing cables are electrically connected to a control module.

### BRIEF DESCRIPTION OF THE DRAWINGS

FIG. 1 is a perspective view of a battery pack including a battery pack interconnect assembly in accordance with an exemplary embodiment.

FIG. 2 is a top view of the battery pack interconnect assembly in accordance with an exemplary embodiment.

FIG. 3 is a top view of the sensing module in accordance with an exemplary embodiment.

FIG. 4 is a side view of the sensing module in accordance with an exemplary embodiment.

FIG. 5 is a top view of the sensing cable in accordance with an exemplary embodiment.

FIG. 6 is a cross-sectional view of the sensing cable in accordance with an exemplary embodiment.

FIG. 7 illustrates the sensing harness in accordance with an exemplary embodiment.

FIG. 8 illustrates a portion of the battery pack interconnect assembly showing the sensing modules coupled to the busbars in accordance with an exemplary embodiment.

FIG. 9 illustrates a portion of the battery pack interconnect assembly showing the sensing harness coupled to the busbars in accordance with an exemplary embodiment.

FIG. 10 illustrates a portion of the battery pack interconnect assembly showing the sensing harness coupled to the busbars in accordance with an exemplary embodiment.

FIG. 11 is a cross-sectional view of the battery pack interconnect assembly taken along line A-A in FIG. 10 in accordance with an exemplary embodiment.

FIG. 12 is a cross-sectional view of the battery pack interconnect assembly taken along line B-B in FIG. 10 in accordance with an exemplary embodiment.

FIG. 13 is a cross-sectional view of the battery pack interconnect assembly taken along line C-C in FIG. 10 in accordance with an exemplary embodiment.

FIG. 14 illustrates a portion of the battery pack interconnect assembly showing the sensing harness coupled to the busbars in accordance with an exemplary embodiment.

### DETAILED DESCRIPTION OF THE INVENTION

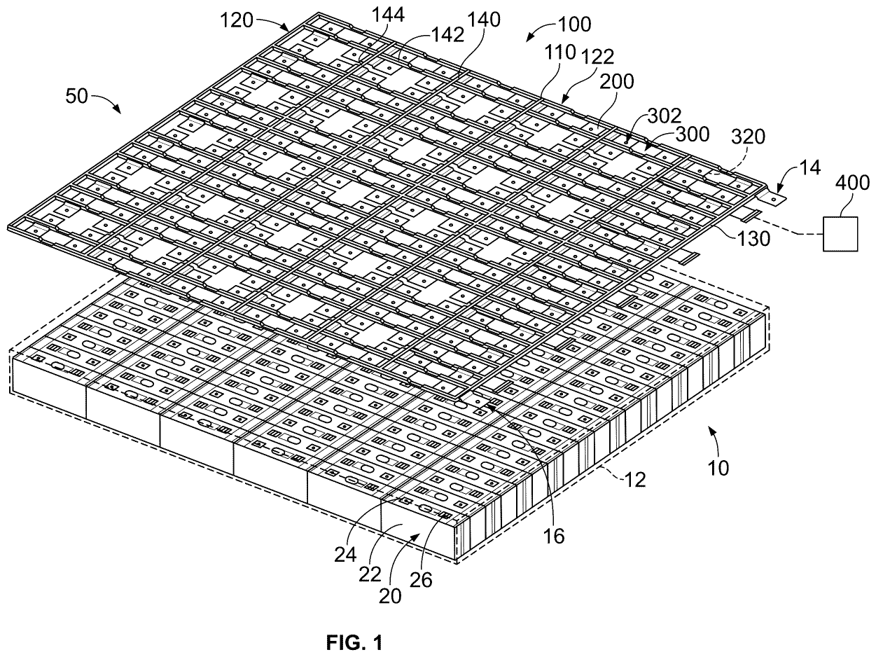

FIG. 1 is a perspective view of a battery pack 10 including a battery pack interconnect assembly 50 in accordance with an exemplary embodiment. The battery pack interconnect assembly 50 includes a busbar interconnect 100 having a plurality of busbars 200 and a sensing harness 300 for sensing parameters of the battery pack, such as voltage, temperature, charge state, or other operating characteristics of the battery pack 10.

The battery pack 10 may be a battery pack for a vehicle, such as an electric vehicle. However, the battery pack 10 may be used in other applications in alternative embodiments. In an exemplary embodiment, the battery pack 10 is a high voltage battery pack. For example, the battery pack 10 may be a 400V or 800V battery pack. The busbar interconnect 100 is used to electrically connect a matrix of battery cells 20 of the battery pack 10. For example, the busbar interconnect 100 may electrically connect the battery cells 20 in series and/or parallel.

The battery cells 20 may be held in a battery pack housing 12. The battery pack 10 includes a positive battery interconnect terminal 14 and a negative battery interconnect terminal 16. The battery interconnect terminals 14, 16 may interface to other power distribution components of the battery pack 10, such as contactors and fuses for connection to a charging system and/or a load, such as an electric motor.

Each battery cell 20 includes a cell housing 22, a first cell terminal 24, and a second cell terminal 26. The battery cell 20 may be a prismatic battery cell in various embodiments. The first and second cell terminals 24, 26 may be cathode and anode terminals. In an exemplary embodiment, the battery cell 20 are rectangular and arranged in a stacked configuration. For example, the battery cells 20 may be stacked in rows and columns of battery cells 20 in the matrix. The cell matrix may have a large surface area, such as greater than two square meters (2 m² or more). For example, the matrix may have a length of between approximately 1.0 m and 2.0 m and a width of between approximately 1.0 m and 1.5 m. Adjacent battery cells 20 in the rows are interconnected by the corresponding busbars 200 of the busbar interconnect 100. Adjacent rows of the battery cells 20 are interconnected by the corresponding busbars 200 of the busbar interconnect 100. For example, end battery cells 20 may be connected row-to-row.

The busbar interconnect 100 includes a busbar carrier 110 holding the busbars 200. The busbar carrier 110 holds the busbars 200 at relative locations for mating with the cell terminals 24, 26 of the corresponding battery cells 20. The busbars 200 electrically connect adjacent battery cells 20, such as in series and/or in parallel. In various embodiments, the busbar carrier 110 integrates all of the busbars 200 into a single unit or structure for mounting to the matrix of battery cells 20. For example, a single busbar carrier 110 may be used to hold all of the busbars 200. In other various embodiments, the busbar carrier 110 may include multiple frames or units, each holding a plurality of the busbars 200, such as a column of the busbars 200. The frames/units may be connected together by other elements of the busbar carrier 110 to form a connected structure.

In various embodiments, the busbar carrier 110 may be a structural foam leadframe that holds the busbars 200. For example, the busbar carrier 110 may be manufactured by a structural foam molding process. The busbar carrier may be manufactured from other materials in alternative embodiments, such as a molded plastic structure. The busbar carrier 110 may be molded or formed on the busbar matrix. For example, the busbar carrier 110 may be overmolded in situ over portions of the busbars 200 to form the busbar interconnect 100. The busbar carrier 110 may be formed around portions of the busbars 200 to hold the busbars 200 relative to each other and relative to the cell terminals 24, 26 of the battery cells 20.

In an exemplary embodiment, the busbar carrier 110 includes a framework or lattice 120. The lattice 120 is formed around portions of the busbars 200 to hold the busbars 200 at relative positions. In an exemplary embodiment, the busbar carrier 110 holds all of the busbars 200 for the battery pack 10 to reduce part count for final assembly to the battery pack 10. For example, the single busbar interconnect 100 is assembled to the battery pack 10. The busbar carrier 110 is used to position the busbars 200 for electrical connection to the cell terminals 24, 26 of the battery cells 20. In an exemplary embodiment, the sensing harness 300 is coupled to the busbar carrier 110. The busbar carrier 110 may be used to position the sensing harness on the battery cells 20.

The lattice 120 includes frame members 122 configured to be coupled to the busbars 200 to hold relative positions of the busbars 200. The frame members 122 include outer frame members 130 surrounding a perimeter of the lattice 120 and inner frame members 140 spanning across an interior of the lattice 120 to interface with the busbars 200. The inner frame members 140 extend between the outer frame members 130. For example, the inner frame members 140 include longitudinal elements 142 and lateral elements 144. The longitudinal elements 142 extend longitudinally across the lattice 120 between the opposite ends. The lateral elements 144 extend laterally across the lattice 120 between the opposite sides. The longitudinal elements 142 and/or the lateral elements 144 may be used to support portions of the busbars 200. The lateral elements 144 interconnect the longitudinal elements 142, such as to provide support to the longitudinal elements 142, and vice versa. In an exemplary embodiment, the inner frame members 140 are formed integral with the outer frame members 130. For example, the inner frame members 140 are formed along with the outer frame members 130 during a structural molding process. The lattice 120 forms a unitary, monolithic structure.

In an exemplary embodiment, the lateral elements 144 span across the columns of busbars 200. The lateral elements 144 engage the busbars 200 to support the busbars 200. The lateral elements 144 support each of the busbars 200 in the corresponding columns. In an exemplary embodiment, the longitudinal elements 142 are located in the gaps between the rows of the busbars 200. In the illustrated embodiment, the longitudinal elements 142 are not used to support the busbars 200. However, in alternative embodiments, the longitudinal elements 142 may additionally or alternatively be used to support some or all of the busbars 200.

In an exemplary embodiment, the sensing harness 300 has sensing points 302 for monitoring the busbars 200 and/or the cell terminals 24, 26. For example, the sensing harness 300 is electrically connected to the busbars 200 at the sensing points 302 to monitor voltage, temperature, charge state, or other operating characteristics of the busbars 200 and/or the cell terminals 24, 26. The sensing harness 300 is configured to be electrically connected to a control module 400, such as a battery control module. The sensing harness 300 sends sensing signals from the sensing points 302 to the control module 400, which may be used to control operation of the vehicle and/or a charging operation of the vehicle.

The battery pack interconnect assembly 50 provides a large format battery cell interconnect assembly that is configured to be mounted to the battery pack 10 (for example, each of the battery cells 20), such as a single unit. The busbar carrier 110 holds the busbars 200 at proper locations for termination to the cell terminals 24, 26 of each of the battery cells 20 of the battery pack 10. By holding the busbars 200 for assembly to the battery cells 20 of the battery pack 10, assembly processes may be eliminated, such as with conventional battery systems where each of the busbars are assembled to the battery cells individually with multiple assembly steps. The busbar interconnect 100 reduces the overall part number count and reduces the number of handled components during assembly of the battery pack 10. The busbar carrier 110 may have a large format and surface area. For example, the structural process to manufacture the lattice framework for the busbar carrier 110 enables a large footprint for the busbar carrier 110. The structural material of the lattice framework for the busbar carrier 110 is dimensionally stable and does not tend to warp making assembly and termination to the battery cells more simple, quicker, and lower cost compared to conventional assembly processes.

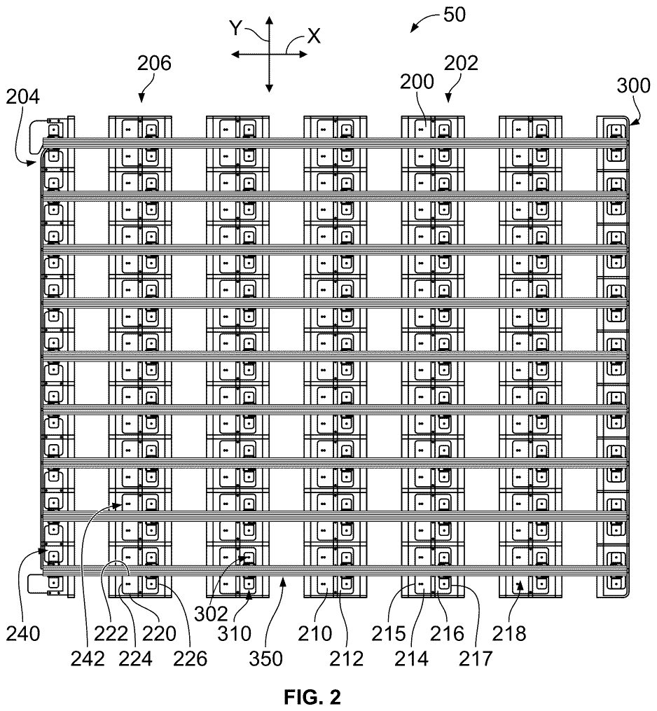

FIG. 2 is a top view of the battery pack interconnect assembly 50 in accordance with an exemplary embodiment. FIG. 2 illustrates a matrix 202 of the busbars 200 and the sensing harness 300 coupled to the busbars 200. The busbars 200 are arranged in rows 204 and columns 206 in the matrix 202. The arrangement of the busbars 200 corresponds to the arrangement of the battery cells 20 to connect to the corresponding cell terminals 24, 26. The sensing harness 300 traverses the rows 204 and columns 206 of the busbars 200 to electrically connect to each of the busbars 200 for sensing characteristics (for example, voltages) of each of the busbars 200.

Each busbar 200 includes a metal plate 210 having a main body 212, a first mating pad 214 at a first mating end 215, and a second mating pad 216 at a second mating end 217. The first mating pad 214 is configured to connect to a cell terminal 24 of one of the battery cells 20. The second mating pad 216 is configured to connect to a cell terminal 26 of an adjacent battery cell 20. The busbar 200 electrically connects the adjacent battery cells 20. The mating pads 214, 216 may include openings 218 therethrough, such as for locating the busbars 200 relative to the cell terminals 24, 26. The openings 218 may be used for a pick and place operation. The openings 218 may be used to hold positions of the busbars 200 during the overmolding process of forming the busbar carrier 110.

In an exemplary embodiment, each busbar 200 is generally rectangular. For example, the busbar 200 includes a first end 220, a second end 222, a first side 224, and a second side 226. The busbar 200 may be elongated, such as having the ends 220, 222 longer than the sides 224, 226. In an exemplary embodiment, the busbar is generally planar. For example, the first and second mating pads 214, 216 may be coplanar for attachment to the cell terminals 24, 26. Optionally, the main body 212 may be offset or out of plane relative to the first and second mating pads 214, 216, such as located above or below the plane of the first and second mating pads 214, 216. The busbar 200 may include mounting features, such as mounting tabs, posts, brackets, clips, notches, openings, and the like for mounting the busbar 200 to the busbar carrier 110.

In an exemplary embodiment, the matrix 202 of the busbars 200 include eighteen rows 204 of the busbars 200 and seven columns 206 of the busbars 200. Greater or fewer busbars 200 may be provided in the rows 204 and/or the columns 206 in alternative embodiments. In an exemplary embodiment, the busbars 200 include outer busbars 240 and inner busbars 242. The outer busbars 240 are arranged along the opposite sides of the busbar matrix 202 (for example, right side and left side). The outer busbars 240 are used to connect between two different rows of the battery cells 20. The inner busbars 242 extend between the outer busbars 240. The inner busbars 242 are used to connect the adjacent battery cells 20 within the same column. The outer busbars 240 are oriented perpendicular to the inner busbars 242. For example, the inner busbars 242 are oriented longitudinally and the outer busbars 240 are oriented laterally. Other orientations are possible in alternative embodiments.

The sensing harness 300 includes sensing modules 310 and sensing cables 350 coupled to each of the sensing modules 310. The sensing modules 310 and the sensing cables 350 form a covering structure that overlaps the matrix 202 of the busbars 200. The sensing modules 310 may extend generally in the Y direction and the sensing cables 350 may extend generally in the X direction. In an exemplary embodiment, the sensing cables 350 are flat flexible cables having a plurality of flat conductors arranged in an insulator configured to be electrically connected to corresponding rows of the sensing modules 310.

In an exemplary embodiment, the sensing modules 310 extend along the columns 206 of the busbars 200 and are electrically connected to the corresponding busbars 200 in the column 206 at the corresponding sensing points 302. The sensing modules 310 sense characteristics, such as voltage, of each of the corresponding busbars 200. The sensing cables 350 span each of the sensing modules 310 and are electrically connected to the sensing modules 310 to aggregate the signals from the sensing modules 310. The sensing cables 350 are electrically connected to the control module 400.

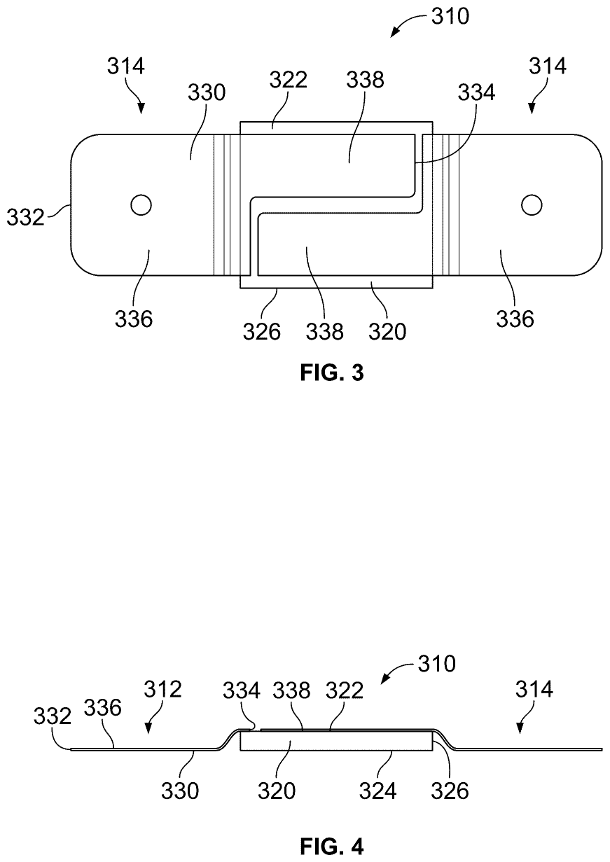

FIG. 3 is a top view of the sensing module 310 in accordance with an exemplary embodiment. FIG. 4 is a side view of the sensing module 310 in accordance with an exemplary embodiment. In an exemplary embodiment, the sensing module 310 includes a sensing housing 320 and one or more sensing circuits. In the illustrated embodiment, the sensing module 310 includes a pair of the sensing circuits, namely a first sensing circuit 312 and a second sensing circuit 314. The sensing module 310 may include greater or fewer sensing circuits 312, 314 in alternative embodiments. In various embodiments, the sensing circuits 312, 314 may be electrically connected to different busbars 200. In other various embodiments, the sensing circuits 312, 314 may be connected to the same busbar 200 to define multiple points of contact with the same busbar 200 and thus define a redundant connection for improved reliability.

In an exemplary embodiment, the sensing housing 320 is manufactured from a dielectric material, such as a plastic material. The sensing housing 320 may be a molded part. In various embodiments, the sensing housing 320 is formed in place on the sensing circuits 312, 314. For example, the sensing housing 320 may be overmolded over portions of the sensing circuits 312, 314. The sensing module 310 may be an overmolded leadframe. In alternative embodiments, the sensing housing 320 may be preformed and the sensing circuits 312, 314 may be coupled to the sensing housing 320. In the illustrated embodiments, the sensing housing 320 includes a top 322, a bottom 324, and side edges 326 between the top 322 and the bottom 324. The sensing housing 320 may be generally rectangular. However, the sensing housing 320 may have other shapes in alternative embodiments. The bottom 324 may be mounted to one or more of the busbars 200 and/or the busbar carrier 110. In an exemplary embodiment, the sensing circuits 312, 314 may extend along the top 322, such as for connection to the sensing cable 350.

The first and second sensing circuits 312, 314 may be similar to each other and include similar structures. Like elements may be identified herein using like reference numerals. The sensing circuit 312 includes a sensing contact 330 extending between a first end 332 and a second end 334. In an exemplary embodiment, the sensing contact 330 is a stamped and formed contact being stamped from a metal sheet and bent or formed into a predetermined shape. The sensing contact 330 may include a busbar. In alternative embodiments, the sensing circuit 312 may include a flexible circuit, such as a flat flexible cable, a flexible printed circuit board, a ribbon cable, or other type of flexible circuit.

The sensing contact 330 includes a first mating tab 336 at the first end 332 and a second mating tab 338 at the second end 334. In the illustrated embodiment, the first and second mating tabs 336, 338 are at different vertical heights. For example, the first mating tab 336 may be generally coplanar with the bottom 324 of the second housing 320 and the second mating tab 338 is generally coplanar with the top 322 of the second housing 320. The first mating tab 336 is configured to be electrically connected to the busbar 200. For example, the first mating tab 336 may be coupled to the busbar 200 by a welded connection, a conductive bonding connection, a staking connection, or a conductive adhesive connection. In the illustrated embodiments, the second mating tab 336 extends along the top 322 of the sending housing 320. The second mating tab 336 is configured to be electrically connected to the sensing cable 350. For example, the second mating tab 338 may be coupled to the sensing cable 350 by a welded connection, a conductive bonding connection, a staking connection, or a conductive adhesive connection.

In an exemplary embodiment, the second mating tabs 338 of the first and second sensing circuits 312, 314 may be overlapping at the top 322. For example, the second mating tabs 338 may bypass each other on opposite sides of the sensing housing 320. The second mating tabs 338 may be spaced apart from each other by a gap. The second mating tabs 338 are electrically isolated from each other for electrical connection to different busbars 200.

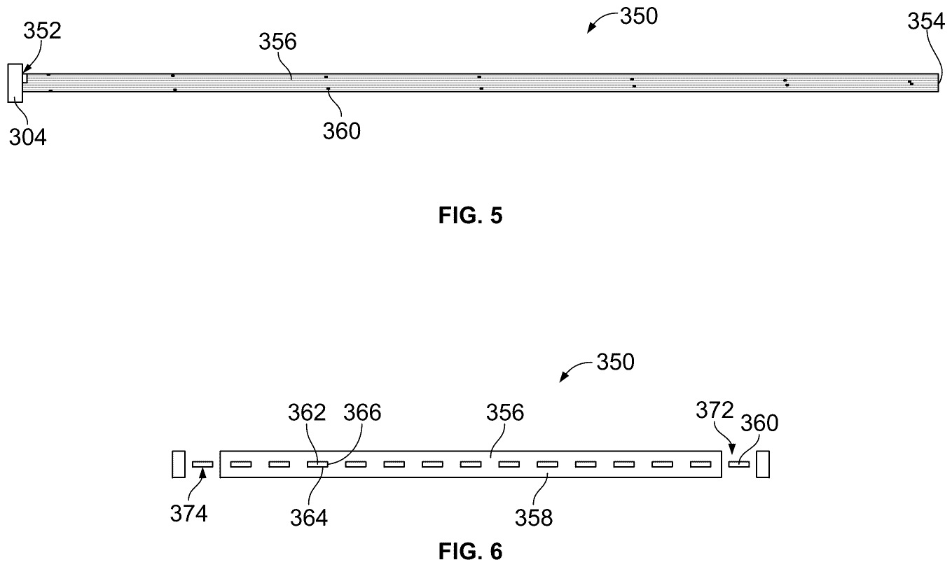

FIG. 5 is a top view of the sensing cable 350 in accordance with an exemplary embodiment. FIG. 6 is a cross-sectional view of the sensing cable 350 in accordance with an exemplary embodiment. In an exemplary embodiment, the sensing cable 350 is a flat flexible cable. The sensing cable 350 extends between a first end 352 and a second end 354. In an exemplary embodiment, an electrical connector 304 is provided at the first end 352. The electrical connector 304 is configured to be electrically connected to the control module 400.

The sensing cable 350 includes an insulator 356 holding a plurality of sensing conductors 360. The insulator 356 may include one or more layers of flexible plastic film 358, such as an upper film, a lower film, and may include one or more intermediate films between the upper and lower films. The layers may be connected by adhesive. The insulator 356 may be a laminated structure. In other various embodiments, the insulator 356 may be extruded around the sensing conductors 360. The sensing conductors 360 are sandwiched between layers of the flexible plastic film 358. The films 358 may be manufactured from a polyester-based material, polyethylene-based material, polyamide-based material, polyurethane-based material, PVC material, and the like. The films 358 may be laminated to each other and/or to the sensing conductors 360, such as using one or more adhesive layers, to form a single, flexible unit.

The sensing conductors 360 are flat, parallel conductors. The sensing conductors 360 may be copper, aluminum, or other metal material. Each sensing conductor 360 includes an upper surface 362 and a lower surface 364. The sensing conductor 360 includes sides 366 between the upper and lower surfaces 362, 364. In an exemplary embodiment, the sensing conductors 360 have a rectangular cross-section. The films 358 cover the upper and lower surfaces 362, 364. The films 358 may be located between the sides 366 of the adjacent sensing conductors 360.

In the illustrated embodiment, the sensing cable 350 includes fifteen of the sensing conductors 360. The sensing cable 350 may include greater or fewer sensing conductors 360 in alternative embodiments, such as to accommodate the number of busbar voltage signals, or other components such as temperature sensors, to be measured, which may be dependent on the number of battery cells. In an exemplary embodiment, the sensing conductors 360 each have the same size (for example, height and width). However, in alternative embodiments, the sensing conductors 360 may have different sizes. In an exemplary embodiment, the sensing cable 350 may have a common pitch or spacing between the sensing conductors 360. However, in alternative embodiments, the sensing cable 350 may have different pitches between the sensing conductors 360.

In an exemplary embodiment, the sensing cable 350 includes connecting access windows 372 exposing the corresponding sensing conductors 360 at joining points 374. For example, portions of the insulator 356 may be selectively removed to form the connecting access windows 372 and expose the sensing conductors 360. In various embodiments, the insulator 356 may be removed by ablation, skiving, cutting, or other removal processes. The connecting access windows 372 provide access to the sensing conductors 360 at the joining points 374 for electrical connection to the sensing circuits 312, 314 of the sensing modules 310. For example, the sensing conductors 360 may be electrically connected to the corresponding sensing circuits 312, 314 by one of a welded connection, a conductive bonding connection, a staking connection, or a conductive adhesive connection. In an exemplary embodiment, the connecting access windows 374 expose different sensing conductors 360 along different segments of the sensing cable 350 for connection to different sensing modules 310. For example, each sensing conductor 360 may be exposed at a different location along the length of the sensing cable 350 for connection to a different sensing module 310.

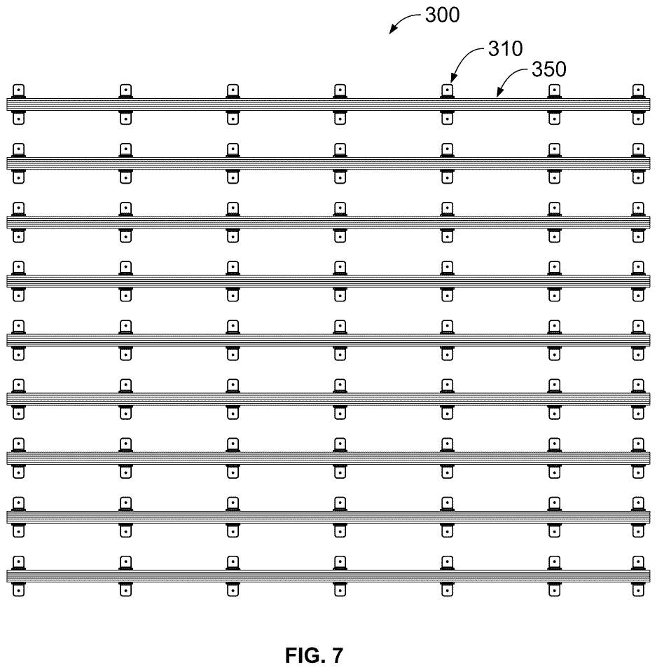

FIG. 7 illustrates the sensing harness 300 in accordance with an exemplary embodiment. The sensing harness 300 includes the sensing modules 310 and the sensing cables 350 coupled to each of the sensing modules 310. The sensing modules 310 are arranged in rows and columns. The sensing cables 350 extend laterally across the sensing modules 310, such as along the rows of the sensing modules 310, to overlap the sensing modules 310 and electrically connect to each of the sensing modules 310 in the corresponding row. The sensing cables 350 are flat flexible cables having a plurality of flat conductors electrically connected to the corresponding sensing modules 310. In an exemplary embodiment, the sensing cables 350 are electrically connected to the sensing modules 310 to form cable harnesses configured to be coupled to the busbars 200. For example, the sensing cables 350 are electrically connected to the sensing modules 310 prior to coupling the sensing modules 310 to the busbars 200. In alternative embodiments, the sensing modules 310 may be coupled to the busbars 200 prior to connecting the sensing cables 350 to the sensing modules 310.

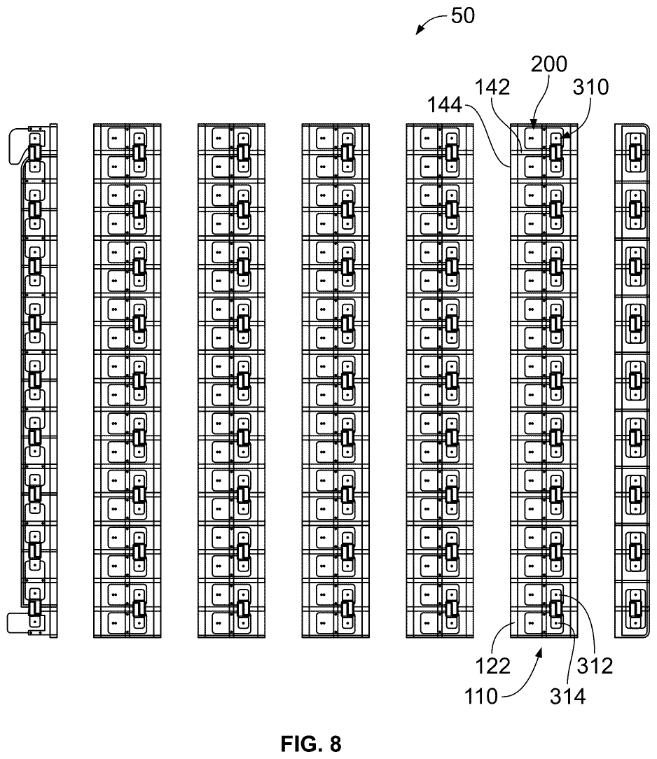

FIG. 8 illustrates a portion of the battery pack interconnect assembly 50 showing the sensing modules 310 coupled to the busbars 200. In various embodiments, the sensing modules 310 may be coupled to the busbars 200 prior to connecting the sensing cables 350 to the sensing modules 310.

When assembled, the sensing modules 310 are coupled to the busbars 200. The sensing modules 310 may be coupled to the busbar carrier 110, such as to the frame members 122. For example, the sensing modules 310 may be coupled to the longitudinal elements 142 and/or the lateral elements 144. The sensing circuits 312, 314 may be electrically connected to the corresponding busbars 200 by one of a welded connection, a conductive bonding connection, a staking connection, or a conductive adhesive connection. The sensing circuits 312, 314 may be welded to the busbars 200 at the same time the busbars 200 are welded to the battery cells, so there is no pre-welding necessary and assembly may be simplified. In alternative embodiments, the sensing circuits 312, 314 could be pre-welded or joined to each other and/or the busbars 200 prior to welding the busbars 200 to the battery cells. In an exemplary embodiment, the sensing circuits 312, 314 are electrically connected to adjacent busbars 200, such as busbars in adjacent rows.

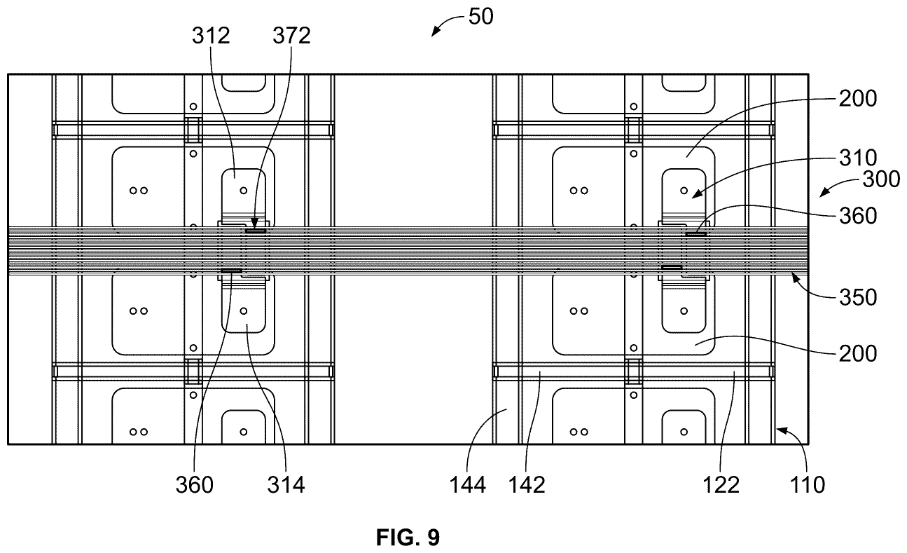

FIG. 9 illustrates a portion of the battery pack interconnect assembly 50 showing the sensing harness 300 coupled to the busbars 200. The sensing modules 310 are coupled to the busbars 200. When assembled, the sensing modules 310 may be coupled to the busbar carrier 110, such as to the frame members 122. When assembled, the sensing cables 350 may be coupled to the busbar carrier 110, such as to the frame members 122. For example, the sensing cables 350 may be coupled to the longitudinal elements 142 and/or the lateral elements 144.

During assembly, the sensing conductors 360 are electrically connected to the sensing circuits 312, 314 at the corresponding joining points. For example, the connecting access windows 372 expose the sensing conductors 360 for electrical connection to the sensing circuits 312, 314. The sensing conductors 360 may be electrically connected to the corresponding sensing circuits 312, 314 by one of a welded connection, a conductive bonding connection, a staking connection, or a conductive adhesive connection. The connecting access windows 374 expose different sensing conductors 360 along different segments of the sensing cable 350 for connection to different sensing modules 310.

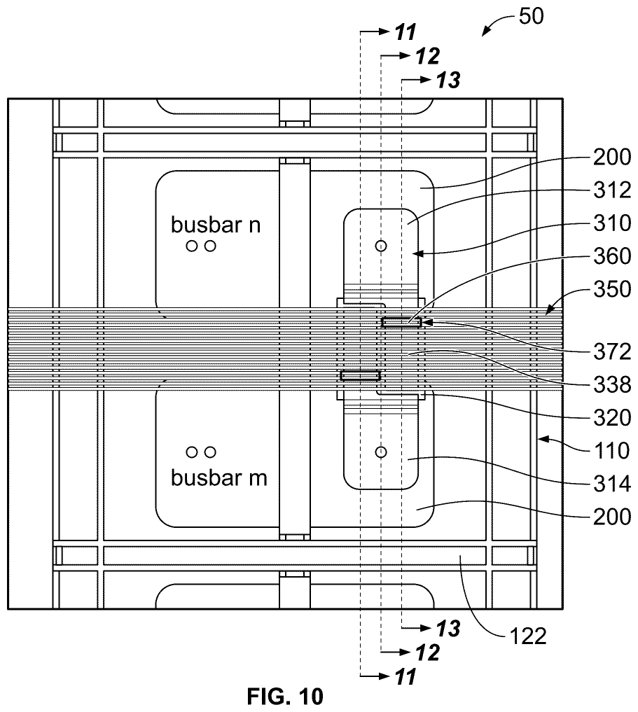

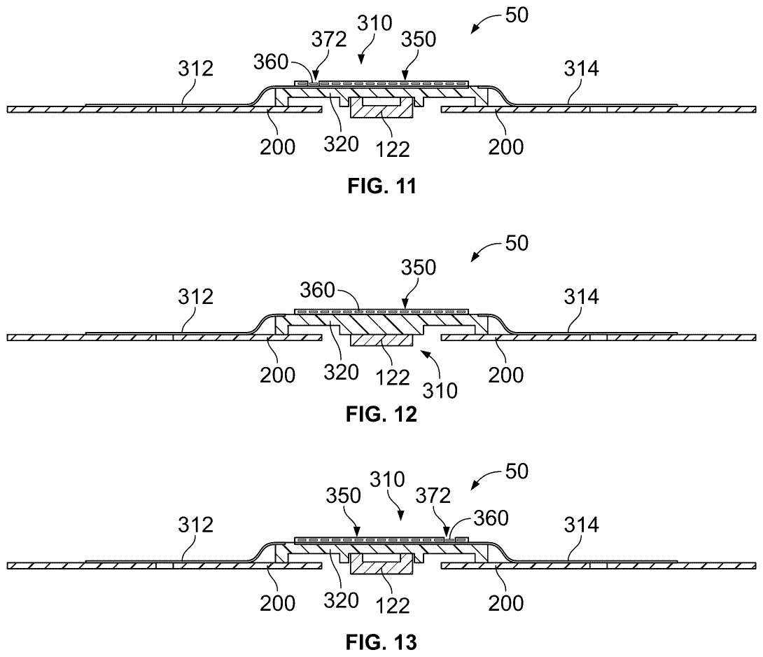

FIG. 10 illustrates a portion of the battery pack interconnect assembly 50 showing the sensing harness coupled to the busbars 200. FIG. 11 is a cross-sectional view of the battery pack interconnect assembly 50 taken along line A-A in FIG. 10. FIG. 12 is a cross-sectional view of the battery pack interconnect assembly 50 taken along line B-B in FIG. 10. FIG. 13 is a cross-sectional view of the battery pack interconnect assembly 50 taken along line C-C in FIG. 10.

The sensing module 310 is coupled to the busbars 200. When assembled, the sensing modules 310 may be coupled to the busbar carrier 110. For example, the sensing housing 320 may be coupled to one of the frame members 122. The sensing housing 320 may be secured to the frame member 122 by adhesive, fasteners, clips, latches, or other securing means. The sensing housing 320 and/or the frame member 122 may include locating features to align and/or position the sensing housing 320 relative to the frame member 122. The sensing housing 320 positions the sensing circuits 312, 314 relative to the busbars 200. For example, the first sensing circuit 312 may be coupled to one of the busbars 200 and the second sensing circuit 314 may be coupled to the adjacent busbar 200.

When assembled, the sensing cable 350 is coupled to the sensing module 310. For example, the sensing conductors 360 are electrically connected to the sensing circuits 312, 314 at the corresponding joining points. In an exemplary embodiment, different sensing conductors 360 are coupled to the mating tabs 338 of the first and second sensing circuits 312, 314. For example, the connecting access windows 372 expose the different sensing conductors 360 for electrical connection to the different sensing circuits 312, 314. The sensing conductors 360 may be electrically connected to the corresponding sensing circuits 312, 314 by one of a welded connection, a conductive bonding connection, a staking connection, or a conductive adhesive connection. The sensing conductors 360 may be welded directly to each other and/or the busbars 200 or an intervening material, such as solder, conductive adhesive and the like may be provided therebetween.

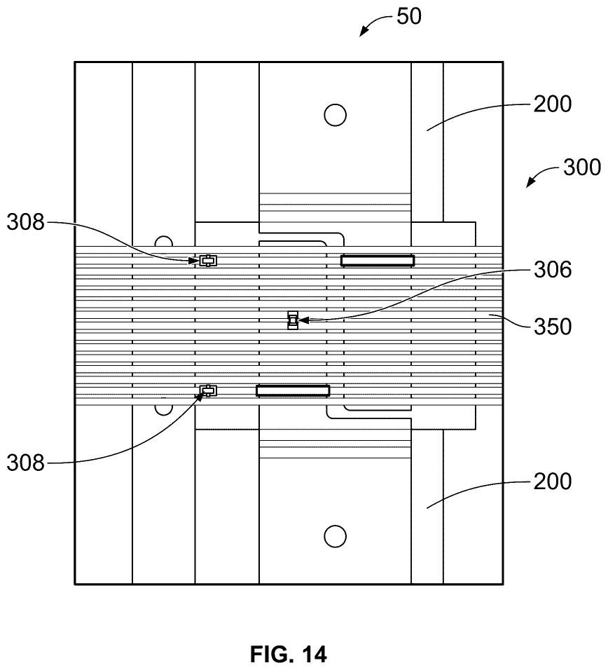

FIG. 14 illustrates a portion of the battery pack interconnect assembly 50 showing the sensing harness 300 coupled to the busbars 200. FIG. 14 shows the sensing harness 300 including a temperature sensor 306 and fuses 308 coupled to the sensing cable 350. The temperature sensor 306 and fuses 308 may be coupled to corresponding sensing conductors 360. The temperature sensor 306 may be an NTC thermistor or other type of temperature sensor.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. § 112(f), unless and until such claim limitations expressly use the phrase “means for” followed by a statement of function void of further structure.

What is claimed is:

1. A battery pack interconnect assembly for electrically connecting cell terminals of battery cells in a battery pack, the battery pack interconnect assembly comprising:
a busbar interconnect including a plurality of busbars arranged in a matrix having multiple rows of the busbars and multiple columns of the busbars and a busbar carrier holding the busbars, each busbar including a first mating end for mating with the corresponding cell terminal of the corresponding battery cell and a second mating end for mating with the adjacent cell terminal of the adjacent corresponding battery cell, the busbars electrically connecting the battery cells in the battery pack; and
a sensing harness having sensing points coupled to the busbars, the sensing harness including sensing modules and sensing cables coupled to the sensing modules, the sensing cables including sensing conductors, the sensing modules including sensing circuits electrically connected to the corresponding busbars at the sensing points to sense a voltage of each of the corresponding busbars, the sensing cables spanning between the sensing modules with the sensing conductors electrically connected to the corresponding sensing circuits of the corresponding sensing modules, the sensing conductors of the sensing cables electrically connected to a control module.

2. The battery pack interconnect assembly of claim 1, wherein the sensing cables are flat flexible cables having flat conductors defining the sensing conductors.

3. The battery pack interconnect assembly of claim 2, wherein the sensing conductors extend parallel to each other and are surrounded by an insulator, portions of the insulator being removed to form access windows to the sensing conductors at joining points, the sensing conductors being electrically connected to the sensing circuits at the joining points.

4. The battery pack interconnect assembly of claim 3, wherein the sensing conductors are electrically connected to the corresponding sensing circuits by one of a welded connection, a conductive bonding connection, a staking connection, or a conductive adhesive connection.

5. The battery pack interconnect assembly of claim 3, wherein the access windows expose different sensing conductors at each of the corresponding sensing modules.

6. The battery pack interconnect assembly of claim 1, wherein the sensing module includes a sensing housing, the sensing circuit held by the sensing housing.

7. The battery pack interconnect assembly of claim 6, wherein the sensing circuit is a first sensing circuit, the sensing module including a second sensing circuit held by the sensing housing.

8. The battery pack interconnect assembly of claim 7, wherein the first and second sensing circuits are electrically connected to different busbars.

9. The battery pack interconnect assembly of claim 7, wherein the first and second sensing circuits are electrically connected to the same busbar forming redundant electrical connections to the busbar.

10. The battery pack interconnect assembly of claim 7, wherein different signal conductors are electrically connected to the first and second sensing circuits.

11. The battery pack interconnect assembly of claim 1, wherein the sensing circuits include stamped and formed sensing contacts.

12. The battery pack interconnect assembly of claim 1, wherein the sensing modules are coupled to the busbars prior to electrically connecting the sensing cables to the sensing modules.

13. The battery pack interconnect assembly of claim 1, wherein the sensing cables are electrically connected to the sensing modules prior to electrically connecting the sensing modules to the busbars.

14. The battery pack interconnect assembly of claim 1, wherein the sensing harness includes one or more temperature sensors coupled to the sensing conductors.

15. The battery pack interconnect assembly of claim 1, wherein the sensing harness includes one or more fuses coupled to the sensing conductors.

16. A sensing harness for sensing voltages of busbars electrically connected to cell terminals of battery cells in a battery pack, the sensing harness comprising:
sensing modules configured to be electrically connected to the corresponding busbars at sensing points to sense a voltage of each of the corresponding busbars, each sensing module including a sensing housing and a sensing circuit held by the sensing housing, the sensing circuits configured to be electrically connected to the corresponding busbars; and
sensing cables extending parallel to each other in rows, the sensing cables being flat flexible cables having a plurality of sensing conductors, the sensing cables spanning each of the sensing modules, the sensing conductors being electrically connected to the corresponding sensing circuits of each of the sensing modules, the sensing conductors of the sensing cables electrically connected to a control module.

17. The sensing harness of claim 16, wherein the sensing cables are flat flexible cables having flat conductors defining the sensing conductors surrounded by an insulator, portions of the insulator being removed to form access windows to the sensing conductors at joining points, the sensing conductors being electrically connected to the sensing circuits at the joining points, wherein the access windows expose different sensing conductors at each of the corresponding sensing modules.

18. The sensing harness of claim 16, wherein the sensing circuit is a first sensing circuit, the sensing module including a second sensing circuit held by the sensing housing, the first and second sensing circuits being electrically connected to different busbars, wherein different signal conductors are electrically connected to the first and second sensing circuits.

19. A battery pack comprising:
battery cells arranged in a matrix having multiple rows and multiple columns of the battery cells, each battery cell including a first cell terminal and a second cell terminal; and
a battery pack interconnect assembly electrically connected to the first and second cell terminals of the battery cells, the battery pack interconnect assembly including a busbar interconnect and a sensing harness electrically connected to the busbar interconnect;
the busbar interconnect including a plurality of busbars arranged in a matrix having multiple rows of the busbars and multiple columns of the busbars and a busbar carrier holding the busbars, each busbar including a first mating end for mating with the first cell terminal of the corresponding battery cell and a second mating end for mating with the second cell terminal of the adjacent corresponding battery cell, the busbars electrically connecting the battery cells in the battery pack;
the sensing harness having sensing points coupled to the busbars, the sensing harness including sensing modules and sensing cables, the sensing cables including sensing conductors, the sensing modules including sensing circuits electrically connected to the corresponding busbars at the sensing points to sense a voltage of each of the corresponding busbars, the sensing cables spanning between the sensing modules with the sensing conductors electrically connected to the corresponding sensing circuits of the corresponding sensing modules, the sensing conductors of the sensing cables electrically connected to a control module.

20. The battery pack of claim 19, wherein the sensing cables are flat flexible cables having flat conductors defining the sensing conductors surrounded by an insulator, portions of the insulator being removed to form access windows to the sensing conductors at joining points, the sensing conductors being electrically connected to the sensing circuits at the joining points, wherein the access windows expose different sensing conductors at each of the corresponding sensing modules.
